(19) United States
(12) Patent Application Publication
(10) Pub. No.: US 2001/0044728 A1
(43) Pub. Date: Nov. 22, 2001

(54) VIRTUAL UNIVERSITY

(76) Inventors: BRIAN M. FREEMAN, SHORT HILLS, NJ (US); MAXIMILIAN A. GRANT, CHICAGO, IL (US); EDWIN EISENDRATH, CHICAGO, IL (US); ANDREW M. ROSENFIELD, LAKE FOREST, IL (US); ENIO OHMAYE, HIGHLAND PARK, IL (US); PATRICK KEATING, HIGHLAND PARK, IL (US)

Correspondence Address: CLIFFORD CHANCE ROGERS & WELLS LLP, 200 PARK AVENUE, NEW YORK, NY, 10166, US

(21) Appl. No.: 09/344,732

(22) Filed: Jun. 25, 1999

Related U.S. Application Data
(60) Provisional application No. 60/116,120, filed on Jan. 15, 1999.

(51) Int. Cl. G06F 17/60

(52) U.S. Cl. 705/1; 434/335

(57) ABSTRACT

A system and method for enabling an established learning institution, such as a first tier college or university, to leverage intellectual capital through licensing and co-developing course content with a Virtual University. The Virtual University develops and markets educational modules presented via a computer communication system. This invention can increase exposure of a professor, course content, and other intellectual capital, to a larger student population separated by time and distance. It can permit multiple learning institutions to participate, with governance and control afforded to each university according to agreed upon guidelines. A Virtual University according to this invention can provide for flexibility in compensation and permit unlimited business arrangements between a university and an institution proffering the educational modules. Compensation arrangements that provide adequate economic participation and reward can include, but are not limited to, cash payments, royalties, minimum guaranteed income, stock and stock options. They may also provide protections for the participating university, including seats on the Board of Directors and other appropriate measures. The system can provide a means for tracking and measuring the use of modules, measurements can be used to calculate compensation. The present invention can avail a traditional a campus based learning institution to a potential market for intellectual capital that is limited not by distance, but by the constraints of a computer communication network utilized. Consumers, embodied as individual students, corporate clients, charter schools or other learner groups can be from varied geographic locations and access the Virtual University system on a basis timely to their particular needs.

### CROSS REFERENCE TO RELATED APPLICATIONS

This application claims the benefit of provisional application entitled “Virtual University,” filed Jan. 15, 1999, bearing the Ser. No. 60/116,120, the contents of which are relied upon and incorporated by reference.

### BACKGROUND

This invention comprises a software learning engine offered online via a network of multimedia nodes. The learning engine can provide an educational experience wherein interactive lessons are utilized and content is designed in cooperation and partnership with academic institutions. Course content can include building blocks of knowledge and be delivered using multiple vehicles. Degrees are granted entirely through online courses. University functions such as registration, administrative tasks, and purchasing course materials are also accomplished online.

Traditional campus based universities are limited by their physical resources in the number of learners to whom they can market their intellectual property. Classroom and campus constraints dictate a relatively small consumer base embodied as learners.

In addition, fixed schedules, passive learning and an academic school year have limited traditional education models utilizing a physical campus with one teacher and many learners. One limitation of the prevailing model is manifested by the model being primarily available only to people during the first stages of their life.

Known methods of offering distance learning have not been able to harness the teaching techniques and material of first tier higher education institutions. Existing methods generally require that a learner become self taught with periodic assessments by the distance learning institution.

There is a need for an educational forum that provides interactive lessons asynchronously such that a learner can participate in a lesson using an on demand schedule and also reap the benefits of an interactive learning environment. A learner should not be bound by geographical constraints. Preferably the educational forum would provide accredited courses and curriculums leading to a degree being granted. Other desirable embodiments can include learning modules directed to a specific need of a customer, for example, a corporation desiring internal education.

### SUMMARY

Accordingly the present invention provides a system and method for enabling an established learning institution, such as a first tier college or university, to leverage intellectual capital through licensing and co-developing course content with a Virtual University. The Virtual University can develop and market educational modules presented via a computer communication system. This invention can increase exposure of a professor, course content, and other intellectual capital, to a larger student population separated by time and distance. It permits multiple learning institutions to participate with governance and control afforded to each university according to agreed upon guidelines.

The present invention can provide for flexibility in compensation and permit unlimited business arrangements between a university and an institution proffering the educational modules. Compensation arrangements that provide adequate economic participation and reward can include, but are not limited to, cash payments, royalties or other performance based compensation, minimum guaranteed income, stock and stock options. They may also provide protections for the participating university, including seats on the Board of Directors and other appropriate measures. The system can provide a means for tracking and measuring the use of modules; measurements can be used to calculate compensation.

In one aspect, the present invention avails a traditional campus based learning institution to a potential market for intellectual capital that is limited not by distance, but by the constraints of an asynchronous computer communication network utilized. Consumers, embodied as individual students, corporate clients, charter schools or other learner groups can be from varied geographic locations and access the Virtual University system on a basis timely to their particular needs.

In another aspect a Virtual University according to this invention can link an established learning institution to a degree granting module provider. This relationship can reduce any risk, including dilution of the learning institution's reputation, and increase its credibility by presenting itself on a worldwide basis. In addition, the institution can act as a quality control agent to insure that course content and delivery meet the standard of the affiliated institution whereby the reputation of the institution can be protected during its affiliation with the course providing Virtual University.

In still another aspect, the course provider can be responsible for degree granting, accreditation and issuance of certificates. However, a Learning Institution can also provide certificates, wherein the certificates issued by the Learning Institution signify satisfactory completion of modules containing the intellectual property of that particular institution.

In one embodiment the invention includes a computer communications system for managing a configuration of learner modules. The modules care co-developed by a learning institution and an online module provider. The system can include a computer communication network with a computer server having a first processor and a storage medium connected to the communications network. A network access device also having a processor as well as a display and an input device can be used to connect to the computer network. Executable software can be stored on the server storage medium and executed on demand via the network access device. The software can be operative with the processors to cause learning modules included in a learning engine to display on the network access device. The learning modules according to this invention will include intellectual capital owned by the learning institution. In one aspect, the intellectual capital can be licensed from the learning institution.

In one aspect the network access device can include a computer. The computer communication network can conform to the transmission control protocol/internet protocol and include the internet or an intranet. Accordingly, WEB interface can be used to access the executable software stored on the server storage medium. In addition, a co-host server can be utilized, accessing a local area network.

In another aspect, a new learner accessing a module can cause a counter to increment such that a cumulative tally is recorded of the number of learners who have accessed a module. The amount of time a learner accesses a particular module and the number of learners to complete a module can also be tracked. Compensation to a learning institution can be based on factors including the number of learners to access modules containing intellectual capital or the number of learners to complete the modules containing intellectual capital furnished by a learning institution.

This invention can also embody a computer system, a programmed computer, a computer program residing on a computer-readable medium, a computer data signal or a method of interacting with a computer and embodying the concepts described above.

The details of one or more embodiments of the invention are set forth in the accompanying drawings and the description below. Implementations can provide advantages such as the capability to leverage intellectual capital and provide learning modules online. Other features, objects, and advantages of the invention will be apparent from the description, the drawings and the claims.

### DESCRIPTION OF THE DRAWINGS

FIG. 1 illustrates the components of a computer system.

FIG. 2 illustrates a computer communications network according to this invention.

FIG. 3 illustrates the relationship between learning institutions, a Virtual University and network access devices.

FIG. 4 illustrates the flow of intellectual property through course design into module versions.

FIG. 5 illustrates tracking learner access to intellectual capital.

FIG. 6 illustrates the formation of courses and the issuance of certificates or degrees.

### DETAILED DESCRIPTION

A learning institution can further leverage its intellectual capital and reach a broader market by linking with a Virtual University. The Virtual University can provide educational services via a computer communications network to learners who access the services with network access devices.

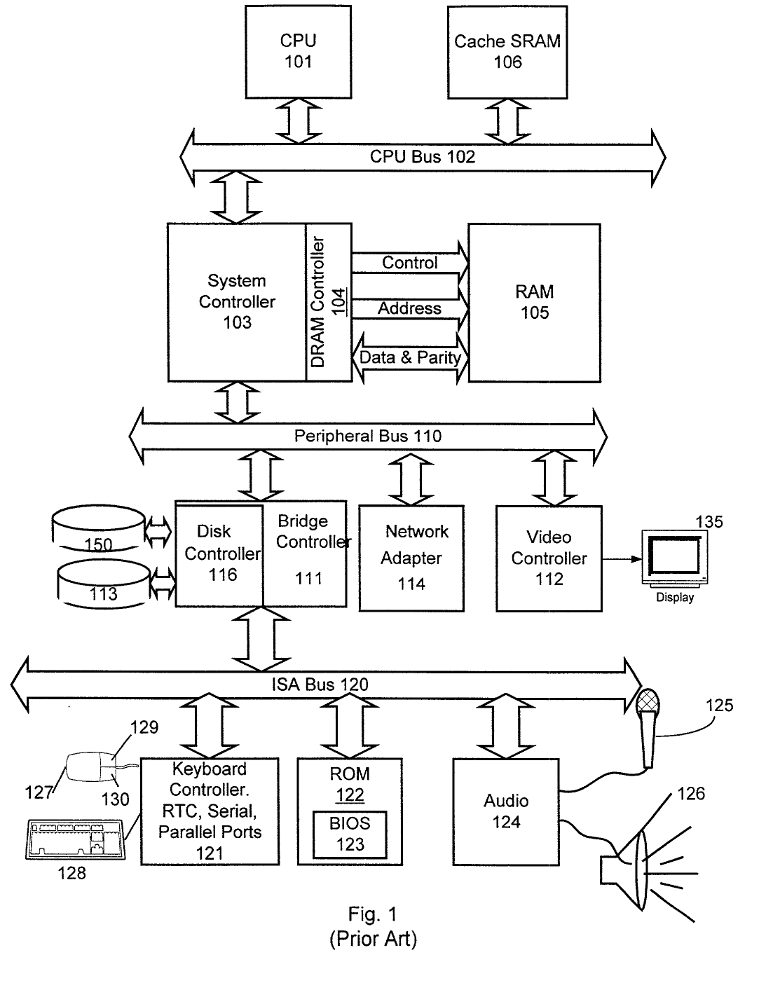

Referring to FIG. 1, physical resources of a computer system 100 are depicted. The computer 100 has a central processor 101 connected to a processor host bus 102 over which it provides data, address and control signals. The processors 101 may be any conventional general purpose single-chip or multi-chip microprocessor such as a Pentium® series processor, a K6 processor, a MIPS® processor, a Power PC® processor or an ALPHA® processor. In addition, the processor 101 may be any conventional special purpose microprocessor such as a digital signal processor or a graphics processor. The microprocessor 101 can have conventional address, data, and control lines coupling it to a processor host bus 102.

The computer 100 can include a system controller 103 having an integrated RAM memory controller 104. The system controller 103 can be connected to the host bus 102 and provide an interface to random access memory 105. The system controller 103 can also provide host bus to peripheral bus bridging functions. The controller 103 can thereby permit signals on the processor host bus 102 to be compatibly exchanged with signals on a primary peripheral bus 110. The peripheral bus 110 may be, for example, a Peripheral Component Interconnect (PCI) bus, an Industry Standard Architecture (ISA) bus, or an Extended Industry Standard Architecture (EISA) bus. Additionally, the controller 103 can provide data buffering and data transfer rate matching between the host bus 102 and peripheral bus 110. The controller 103 can thereby allow, for example, a processor 101 having a 64-bit 66 MHz interface and a 533 Mbytes/second data transfer rate to interface to a PCI bus 110 having a data path differing in data path bit width, clock speed, or data transfer rate.

Accessory devices including, for example, a video display controller 112 and network controller 114 can be coupled to the peripheral bus 110. The network controller 114 may be a modem, an Ethernet networking card, a cable modem, or other network access device. The system 100 may also include a secondary peripheral bus 120 coupled to the primary peripheral bus 110 through a bridge controller 111. The secondary peripheral bus 120 can be included in the system 100 to provide additional peripheral device connection points or to connect peripheral devices that are not compatible with the primary peripheral bus 110. For example, in the system 100, the secondary bus 120 may be an ISA bus and the primary bus 110 may be a PCI bus. Such a configuration allows ISA devices to be coupled to the ISA bus 120 and PCI devices to be coupled to the PCI bus 110. The bridge controller 111 can also include a hard disk drive control interface to couple a hard disk 113 to the peripheral bus 110.

The computer 100 can also include non-volatile ROM memory 122 to store basic computer software routines. ROM 122 may include alterable memory, such as EEPROM (Electronically Erasable Programmable Read Only Memory), to store configuration data. For example, EEPROM memory may be used to store hard disk 113 geometry and configuration data. BIOS routines 123 are included in ROM 122 and provide basic computer initialization, systems testing, and input/output (I/O) services. For example, BIOS routines 123 may be executed by the processor 101 to process interrupts that occur when the bridge 111 attempts to transfer data from the ISA bus 120 to the host bus 102 via the bridge 111, peripheral bus 110, and system controller 103. The BIOS 123 also includes routines that allow an operating system to be “booted” from the disk 113 or from a server computer using a local area network connection provided by the network adapter 114.

An operating system may be fully loaded in the RAM memory 105 or may include portions in RAM memory 105, disk drive storage 113, or storage at a network location. An operating system can provide functionality to control computer peripherals and to execute user applications. Examples of high-level operating systems are, the Microsoft Windows 98™, Windows NT™, a UNIX™operating system, the Apple MacOS™ operating system. The operating system can provide functionality to execute software applications 150, software systems and tools of software systems. Software functionality can access the video display controller 112 and other resources of the computer system 100 to provide educational modules on a computer screen and through other multimedia aspects of the computer 100. User applications 150 may be commercially available software programs such as a collaborative apprenticeship software, word processor, spreadsheet, database, internet access software and many other types of software.

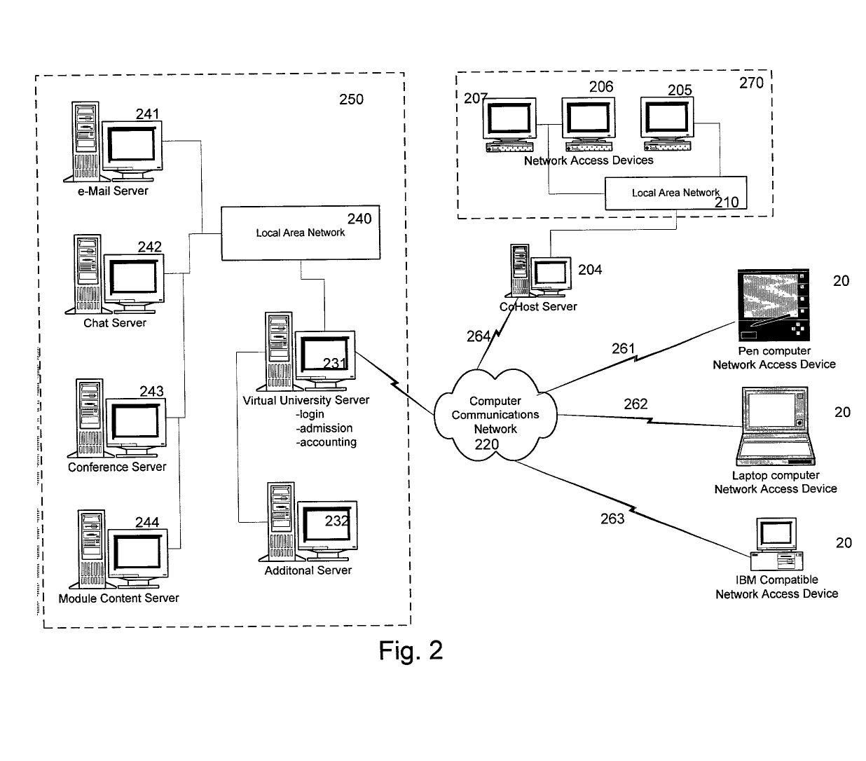

Referring now to FIG. 2, a collection of computers 100 can serve as components of a computer network 200. A computer network 200 can include a host computer system 250 and client computers 201-207. The client computers 201-207 can communicate with the host 250 to obtain data stored at the host 250 on servers 241-244. The client computer 201-207 may interact with the host computer 250 as if the host was a single entity in the network 200. However, the host 250 may include multiple processing and database sub-systems that can be geographically dispersed throughout the network 200.

In addition, client computers may include a tightly coupled cluster 205-207 of computers 100 at a first location that access data systems 2241-244 at remote locations. Each data system 241-244 may include additional processing components.

Client computers 201-207 can communicate with the host system 250 over wired or wireless mediums, for example, a private network or a combination of public switched telephone network dial-up connections and packet network interconnections. For example, client computers 201-203 may each include a modem coupled to voiceband telephone line 261-263. To communicate with the host 250, the client computers 201-203 establish a data connection with a local terminal server 225 by dialing a telephone number assigned to the local terminal server 225. A local terminal server 225 may have both dial-up and packet network interfaces allowing the server 225 to receive data from client computers 201-203, segment the received data into data packet payload segments, add overhead information to the payload segments, and send the resultant data packets over a link 221 to a packet data network 220 for delivery to the host system 250. Terminal servers 231 and 232 may also be referred to as a network service provider's point-of-presence (POP).

The overhead information added to the payload segments include a packet header. A packet header includes a destination address assigned to the host system 250 and a source address assigned to a local terminal server 231. Other overhead information may include information associating the data packet with a specific client 201-203. Similarly, the host system 250 may send data to a client 201-203 by segmenting the data into data packet payload segments, and adding overhead information to send the data packet to a client 201-203 at the terminal server 225. Client computers 205-207 may similarly exchange data with the host 250 over communications link 264 to terminal server 231.

Data packet formats, switching equipment within the network 220, and networking protocols used within the network 220 may conform to the transmission control protocol/internet protocol (TCP/IP). In a TCP/IP implementation, the host 250, packet network terminal server 231 is assigned a unique internet protocol (IP) network address. TCP/IP switching equipment within the network 220 can direct a TCP/IP packet to an intended recipient based on the packet's destination IP address. Implementations may use other networking protocols and packet formats.

In one embodiment of the present invention a “co-host” server 204 is utilized to provide more expedient responses. In a co-host environment 270, a server 204 or cluster of servers can be connected to a local area network (LAN) 210 to serve course content and provide Virtual University administrative services such as e-mail, chat sessions, accounting, admissions and login, as well as educational services including conferences and course content. An in-house connection to the LAN can provide greater speed and reliability in delivery of server content to a workstation. In addition, in-house servers can be used to localize technical support services.

Client workstations 201-207 can comprise a computer as described above or another WEB access device that adheres to a protocol such as the Internet protocol. Other examples include for example, TV WEB browsers, terminals, and wireless access devices. Preferably an access device comprises a display capability, an input device and an electronic storage device.

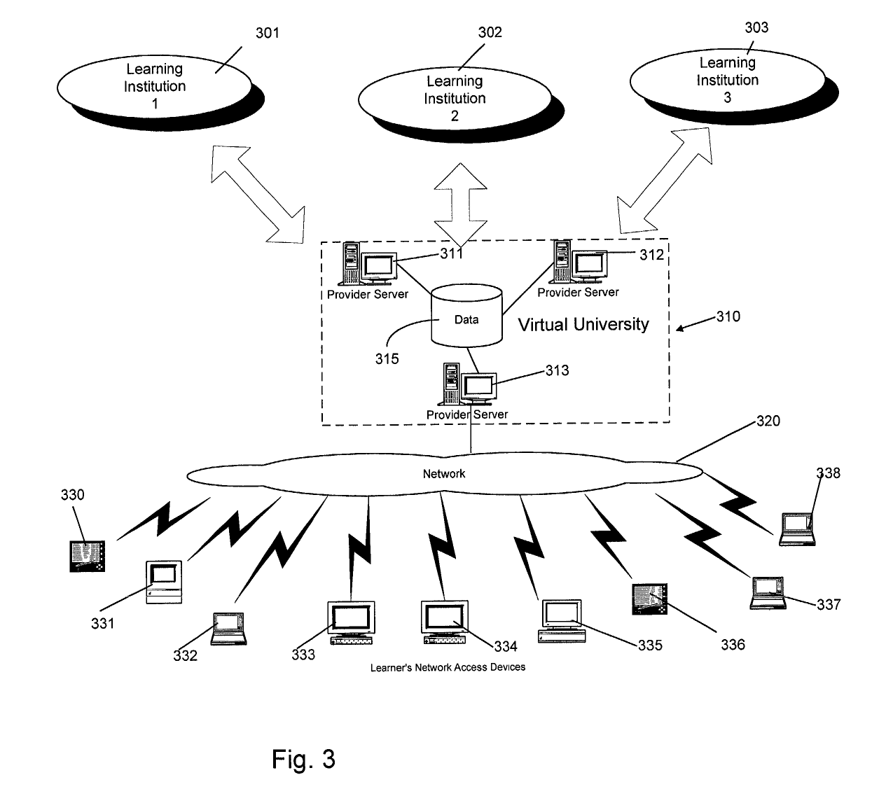

Referring now to FIG. 3, a Virtual University can be structured such that learning institutions 301-303, including first tier colleges and universities, interact with a Virtual University course provider to co-develop learning engines that will be used to educate. Learning institutions can offer material for course modules, personnel, educational consultants, quality assurance experts and other resources. The Virtual University entity 110, can transform input from a learning institution 101-103 into modules for instruction. Modules and software program code relating to each module, can be stored on a storage medium 315 such as a disk drive or other storage device suitable for maintaining data. Network access devices 130-138, accessing a computer communications network 120 and linked to the Virtual University 110 can be granted access to the modules stored on the storage medium 115.

In addition to WEB access to the course content it is possible to download onto a personal computer or other electronic device interactive material so that lesson modules can be conducted off-line.

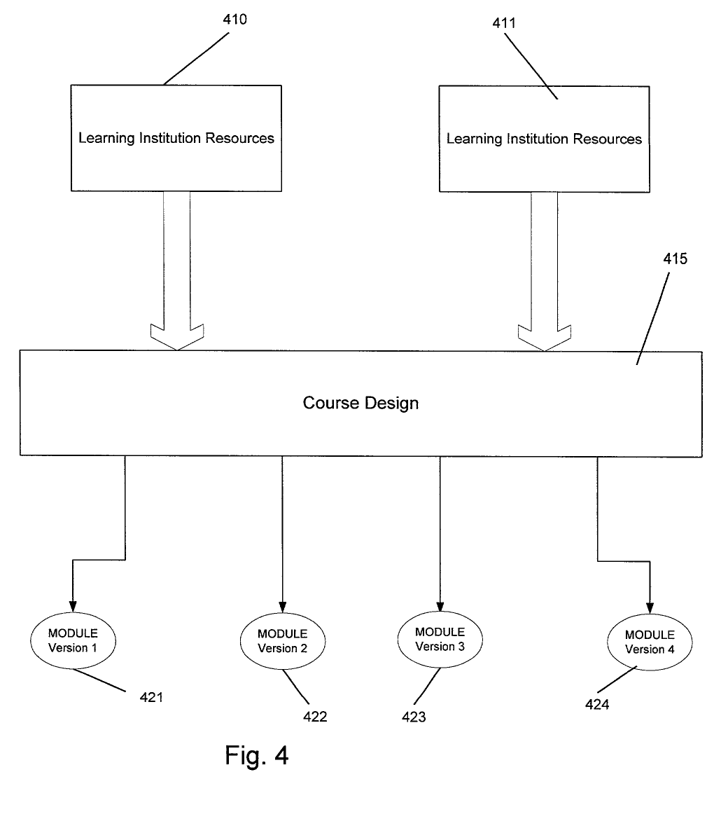

Referring now to FIG. 4, a learning institution can provide resources including course content, syllabus and personnel into a course design process. The resources 410 and 411 are transformed in a course design 415 facilitated by the Virtual University. After the resources 410 and 411 have been transformed in the course design 415 resultant modules 421-424 can be used as the learning vehicle of the Virtual University 310.

The resultant modules 421-424 can embody dynamic resources 410 and 411. As the content, syllabus or personnel evolve and are updated, the course design process 415 can issue new versions of the course modules 421-424 responsive to such changes. Therefore, a module version one, 421 can embody an earlier generation of resources 410 and 411, and a module version two, 422 can contain updated intellectual property.

In one embodiment, intellectual property submitted as resources from a first learning institution 410 can be kept segregated from intellectual property belonging to a second learning institution 411. Segregation of the intellectual property of a particular learning institution 410, can be useful in determining the compensation to be rendered to the contributing learning institution. In addition, a learning institution 301-303 may better perform quality control over learning modules 421-424 that will be associated with the learning institution 301-303 if there is a clear delineation between modules 421-424 that contain the intellectual property of a contributing institution. Quality control measures can include mandating course content, editing course presentation, assuring a delivery vehicle functions properly and any other aspect that may compromise the reputation of the learning institution.

In another embodiment, a Virtual University 310, can combine resources 410-411 from multiple learning institutions 301-303. A combination of intellectual property from multiple sources, can allow a Virtual University 310 to fashion a unique product during the course design stage 415 such that the learning modules 421-424 contain material not available in any other one place.

Intellectual property contributed by a learning institution can include copyrighted text, copyrighted videos, trademarks, tradenames, trade secrets and other materials. Learning institution personnel can appear in video or audio segments to present contributed course material. Reference materials including text and graphic documents can also be made available.

Combining the utilization of a computerized communications network and software modules enables Virtual University instruction to be accomplished through asynchronous learning. Asynchronous learning allows a learner to access educational material at a time convenient to the learner. It relieves a learner of scheduling conflicts often inherent in traditional learning institutions.

The use of modules can also allow a breaking of linearity that is often associated with traditional instructor lead courses. Modules can be located, experienced, referenced, and refreshed online, by a learner. Tools used to convey knowledge elements can include video clips, audio clips, simulations, animated concepts, multimedia presentations and passive illustrations.

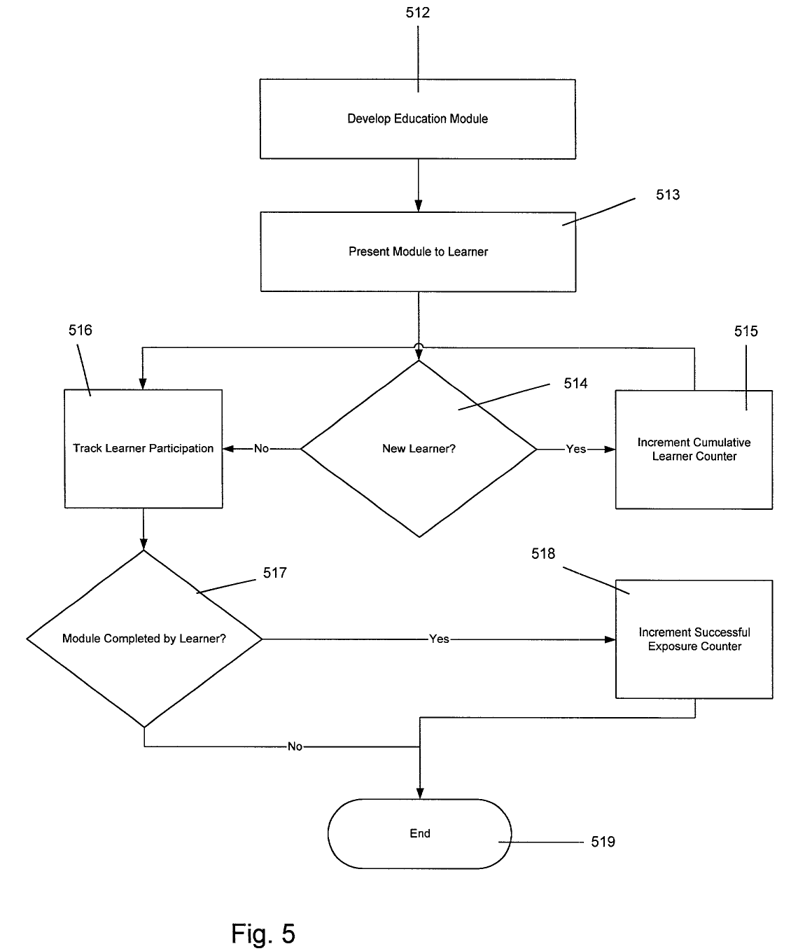

Referring now to FIG. 5, an education module that has been developed and stored in the Virtual University 512 can be accessed by a learner 513 via a computer communications network 320. The module can be presented to the learner on a network access device 330-338. Software code operative on a Virtual University server 311-313 can determine if the learner accessing the module is a new learner 514 accessing this particular module for the first time. In one embodiment, a positive response to the determination step testing for a new learner 514 can increment a cumulative learner counter 515. After a learner has entered a module, the software code can be operative to track learner participation 516 as the learner progresses through the module. Progression will be further discussed below. In addition, the system can determine whether a module is completed by a learner 517. In one embodiment, completion of a module by a learner 517 will cause the system to increment a successful exposure counter 518.

A Virtual University can track performance of individual modules and courselets to calculate performance based compensation to a learning institution. For example, counters 515 & 518 can be used to monitor the number of new learners who commence a course and are thereby given access to intellectual property traceable to a learning institution. In addition, the counters can tally the number of learners who complete a particular learning module. A learning institution can be compensated according to the number of learners to whom their intellectual capital is marketed. Additional compensation can be awarded according to the number of learners who complete a related module.

Compensation arrangements to learner institutions can include, but are not limited to cash payments for resources, royalties for intellectual property such as trademarks or copyrighted material and minimum guaranteed income. In addition, a learning institution can be awarded stock in the Virtual University course provider or stock options. Other protections to the learner institutions can be garnered from guaranteed seats on a board of directors or other appropriate measures.

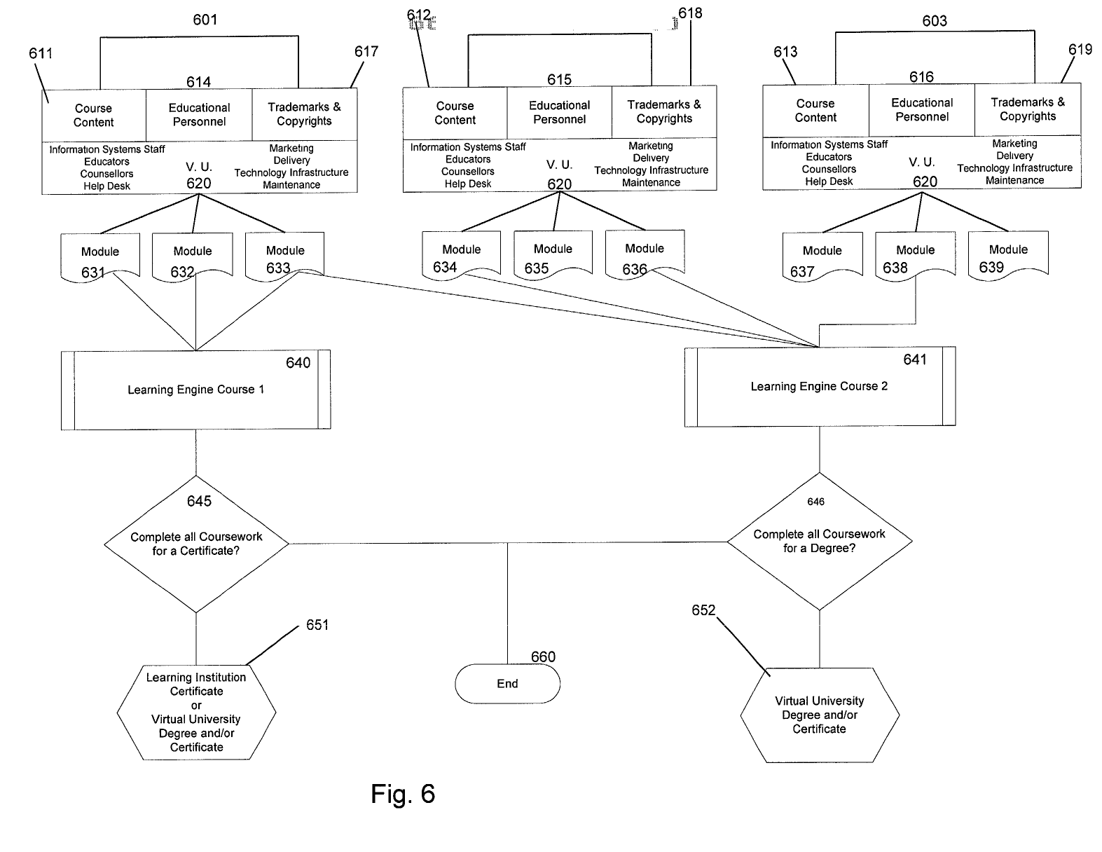

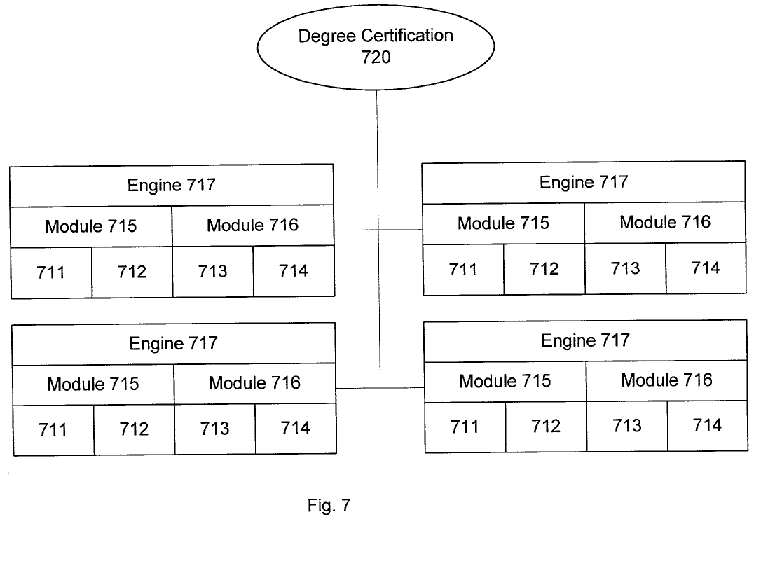

Referring now to FIG. 6, a Virtual University 310 can receive course content 611-613, educational personnel 614-616 as well as the rights to utilize trademarks, copyrights and other intellectual property 617-619 from various learning institutions 601-603. Virtual University contributions 620 can include information systems staff, educators, education counselors, help desk services, marketing of the Virtual University products, delivery of the Virtual University products, technology infrastructure, infrastructure maintenance and other support services, personnel and hardware. Modules 631-639 co-developed by the Virtual University 620 and the learning institutions 601-603 can be organized into learning engines 640 and 641 wherein each learning engine contains the resources necessary to complete a course. The learning engine courses 640-641, can include one or more modules 631-639. In one embodiment, a course includes modules 631-633 that are co-developed with a single learning institution 601. In another embodiment, a course 641 includes modules co-developed with multiple learning institutions 601-603.

Software operative on a Virtual University server 311-313 can track module completion and determine if a learner has completed specified modules required for a certificate 645. In one embodiment, a learning institution can grant a certificate for completion of a course that includes modules containing intellectual property of that particular learning institution 651. In addition, the Virtual University can grant a degree and/or a certificate upon satisfactory completion of required course work 651-652.

Referring now to FIG. 7, application software modules 715-716 operative with the processor 101 can be developed into a learning engine 717. A learning engine can contain material equivalent to one course. Elements 711-714, also referred to as courselets, in turn can make up learning modules 715-716. Each learning engine 717 can include one or more modules 715-716. Individual modules can be edited as a course becomes more refined over time, or as content changes with new scientific discoveries without disturbing the entire application. In one embodiment, a module can be accessed from more than one learning engine. In addition, alternative learning modules can be referenced to adapt and remediate to a particular learners needs 513. Completion of required learning modules can lead to certification with the granting of an online degree 720.

In one embodiment, elements or courselets can be utilized in various modules. An object oriented structure can be used to facilitate adapting the elements into multiple scenarios. In addition, the use of elements can allow a course provider, such as a Virtual University, to update dynamic course content as required without recreating an entire module. Only the elements that require updating need to be replaced.

In addition to learning engines, this invention can utilize real time team exercises facilitated through the communications network 200. Team exercises can include multimedia based projects implemented via the network 200 to facilitate learners working collectively and cooperatively during the performance of projects. These exercises provide personal interactions and simultaneously teach virtual teaming, an additional skill useful in a business or other environment. The combination of a learning engine and a real time team exercise can provide a learner with flexibility in scheduling and the benefits of interacting with other learners. For example, an on-line business program can prepare learners to understand and use essential business concepts and, in addition, it can teach the learners to reason and communicate effectively using those concepts.

Periodically, learners can engage in synchronous group activities that run on a fixed schedule, such as labs. In lab activities, a learner can work with others to synchronize discussions and prepare deliverables to mentors, team members, or other members of the lab. In one embodiment, a learner can participate with a group of approximately 4-6 learners who serve as lab partners. Other embodiments include the use of chat rooms. Chat rooms dedicated to a specific team can be particularly effective.

Learning engine resources, including modules and labs can be presented online through a WEB interface. A network interface device 201-207 can access a resource through an interactive network interface, such as a WEB interface. A WEB based interface can include, for example, a hypertext markup language (HTML) document presented as a network site and accessible with a uniform resource locator or TCPIP address. Other markup languages may also be utilized such as extended markup language (XML). Through a WEB based interface, such as a My.Campus screen, a learner can communicate with others, create and update an individual work plan, access needed resources, store work, and stay up to date. While online, learners may create work groups with other learners, use a suite of business tools, check with a registrar, or open a library data base. In addition, learners can store a project, present the project to others, or review work of fellow learners.

The invention may be implemented in digital electronic circuitry, or in computer hardware, firmware, software, or in combinations of them. Apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

Software for organizing and delivering information stored on the server computers can include for instance Learning Space™ by Lotus Development Corporation or Oracle™ database products. The invention may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors.

Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices, magnetic disks such as internal hard disks and removable disks, magneto-optical disks, and CD-ROM disks. Any of the foregoing may be supplemented by, or incorporated in, specially-designed application-specific integrated circuits (ASICs).

The course content for delivery over the WEB can be developed in conjunction with qualified learning institutions. An institution can provide professors or other institution affiliates to act as consultants in developing course content. In addition the professors can create video clips, audio clips, simulations, animated concepts, multimedia presentations and passive illustrations to be used during the instructional sessions. The institution can act as a quality control agent to insure that course content and delivery retain quality representative of institutions standards.

The course provider can be responsible for degree granting and accreditation. Affiliated institutions can also provide certificates. The certificates can acknowledge successful completion of the modules developed by the affiliated institution.

What is claimed is:

1. A method of instructing a learner via a computer communications network, the method comprising:
co-developing a learning module by an online course provider and a learning institution;
hosting the learning module on a server, wherein the server is accessible via a computer communications network;
tracking learner access to the learning module;
acknowledging satisfactory completion of activities comprising the learning module; and
compensating the learning institution relative to the number of learners who access the learning module.

2. The method of claim 1 additionally comprising the steps of:
tracking multiple predetermined learner modules; and
awarding an accredited degree responsive to satisfactory completion of the predetermined modules by the learner.

3. The method of claim 1 additionally comprising the steps of:
monitoring a number of incorrect responses input by a learner performing exercises comprising a learning module; and
making additional resources available to a learner who exceeds a predetermined number of incorrect responses.

4. The method of claim 1 additionally comprising the steps of:
monitoring the amount of time that elapses while a learner accesses a learning module; and
making additional resources available to a learner who exceeds a predetermined amount of time.

5. The method of claim 1 wherein the learner module is accessed via an interactive WEB interface.

6. The method of claim 1 wherein the learning institution is compensated according to the number of learners who complete work assignments associated with the learning module.

7. The method of claim 1 additionally comprising the step of awarding the learning institution an equity position on the course provider.

8. The method of claim 1 additionally comprising the step of allocating quality control measures to the learning institution.

9. A computer communications system for managing a configuration of learner modules, wherein a learner module is co-developed by a learning institution and an online learning module provider, the system comprising:
a computer communications server accessible with a network access device via a computer communications network; and
executable software stored on the server and executable on demand via the network access device, the software operative with the server to cause a learning module to display on the network access device, wherein the learning modules comprise intellectual capital owned by said learning institution.

10. The computer communications system of claim 9 wherein the intellectual capital comprises course content.

11. The computer communications system of claim 9 wherein the network access device comprises a computer.

12. The computer communications system of claim 9 wherein the computer communication network conforms to the transmission control protocol/internet protocol.

13. The computer communications system of claim 9 wherein the computer communication network comprises an intranet.

14. The computer communications system of claim 9 additionally comprising a WEB interface for accessing the executable software stored on the server storage medium.

15. The computer communications system of claim 9 additionally comprising a co-host server accessing a local area network.

16. The computer communications system of claim 15 wherein the co-host server provides Virtual University administrative services.

17. The computer communications system of claim 9 wherein the software is additionally operative with the computer server to cause a counter to increment when a learning module is accessed by a new learner.

18. The computer communications system of claim 9 wherein the software is additionally operative with the computer server to cause an acknowledgment of completion to issue in response to completion of a predetermined set of modules.

19. Computer executable program code residing on a computer-readable medium, the program code comprising instructions for causing the computer to:
incorporate intellectual capital owned by a learning institution into a learning module presented by an online course provider;
serve the learning module on a server accessible through a computer communications network;
track the access of a learner accessing the learning module;
acknowledge satisfactory completion of activities comprising the learning module; and
compensate the learning institution relative to the number of learners who access the learning module.

20. The computer executable program of claim 19 wherein the program code additionally causes the computer to:
determine the eligibility of a learner to receive an accredited degree resultant to completion of a predetermined set of learner modules.

21. The computer executable program of claim 19 wherein the computer communications network is a Transmission Control Protocol/Internet Protocol network.

22. A method of interacting with a network access device so as to provide instruction to a learner, the method comprising the steps of:
accessing a server on a computer communications network, wherein the server is hosting learner modules co-developed by a learning institution and a Virtual University;
performing activities relating to the a learner module accessed; and
submitting cognitive artifacts resultant from the activities performed.

23. A computer data signal embodied in a digital data stream comprising data including education modules, wherein the computer data signal is generated by a method comprising the steps of:
incorporating intellectual capital owned by a learning institution into a learning module presented by an online course provider;
serving the learning module on a server accessible through a computer communications network;
tracking the access of a learner accessing the learning module;
acknowledging satisfactory completion of activities comprising the learning module; and
compensating the learning institution relative to the number of learners who access the learning module.

24. A computer data signal as in claim 21 wherein the signal generated adheres to the transmission control protocol/internet protocol.
